(19) United States
(12) Patent Application Publication
(10) Pub. No.: US 2014/0282666 A1
(43) Pub. Date: Sep. 18, 2014

(54) Systems and Methods for Content History

(71) Applicant: COX COMMUNICATIONS, INC., Atlanta, GA (US)

(72) Inventors: Brent Joseph Comstock, Atlanta, GA (US); Louise Mary Wasilewski, Atlanta, GA (US)

(21) Appl. No.: 14/211,985

(22) Filed: Mar. 14, 2014

Related U.S. Application Data
(60) Provisional application No. 61/793,045, filed on Mar. 15, 2013.

(51) Int. Cl. H04N 21/24

(52) U.S. Cl. CPC H04N 21/2407
USPC 725/18; 725/14

(57) ABSTRACT

Systems and methods for determining and storing a content viewing history and/or content experience of one or more users are disclosed. The content viewing history may be stored in a content information account associated with the one or more users. Bookmarks associated with content and/or secondary content associated with the content, or indications thereof, may also be stored in the content information account associated with the one or more users.

### CROSS-REFERENCE TO RELATED APPLICATIONS

The present application claims priority under 35 U.S.C. §119(e) to pending U.S. Provisional Application No. 61/793,045, filed on Mar. 15, 2013, the entire contents of which is hereby incorporated herein by reference in its entirety for all purposes.

### TECHNICAL FIELD

This invention generally relates to methods, systems and apparatus for content and, in particular, generating a content history.

### BACKGROUND

Media content, such as audio and video, may be delivered to subscribers of media services, such as cable television subscribers, via a communications network, such as a cable television network. In such systems, a content delivery network, or a network of various servers, may provide the media content to a client device, such as a set top box or gaming console at a subscriber location. In some cases, the media content may be delivered via the Internet, such as in a streaming format. In yet other cases, the content may be delivered in a downloadable form and/or physical form. A user may wish to track content that he/she receives or consumes from a variety of sources.

### BRIEF DESCRIPTION OF THE FIGURES

Reference will now be made to the accompanying drawings, which are not necessarily drawn to scale, and wherein:

FIG. 1 is a simplified schematic diagram illustrating an example content consumption architecture that may be operated in accordance with embodiments of the disclosure.

FIG. 2 is a simplified block diagram illustrating a user device of the content consumption architecture of FIG. 1 in accordance with embodiments of the disclosure.

FIG. 3 is a simplified block diagram illustrating a video back office server of the content distribution architecture of FIG. 1, in accordance with embodiments of the disclosure.

FIG. 4 is a flow diagram illustrating an example method for storing content history associated with a user, in accordance with embodiments of the disclosure.

FIG. 5 is a flow diagram illustrating an example method for viewing a user's viewing history, in accordance with embodiments of the disclosure.

FIG. 6 is a flow diagram illustrating an example method for generating a viewing history associated with the user, in accordance with embodiments of the disclosure.

FIG. 7 is a simplified diagram illustrating a user interface on a user device for rendering content and providing metadata for generating a user content history, in accordance with embodiments of the disclosure.

FIG. 8 is a simplified diagram illustrating a user interface on a user device for showing a content consumption history associated with a user, in accordance with embodiments of the disclosure.

### DETAILED DESCRIPTION OF EMBODIMENTS OF THE DISCLOSURE

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Embodiments of the disclosure as disclosed herein may include systems and methods for storing a content consumption history and/or content experience of one or more users. The stored content associated with the one or more users may be accessed and/or retrieved at any time. The systems and methods may further enable the one or more users to embellish his/her/their content consumption history with a variety of bookmarks, quotes, other content, or links and/or indications thereto, metadata, images, video, haptic signals, olfactory signals, or the like. The systems and methods may further be configured to receive user input to update records and/or indications of content received and/or rendered to the one or more users. As used herein, the term “content” may include, but is not limited to any variety of suitable analog and/or digital content such as movies, television shows, video or other games, games, other video content, graphical content, metadata, application code, music, other audio content, olfactory content, haptic content, other digital content, combinations of the foregoing, and the like.

The systems and methods, in accordance with embodiments of the disclosure, may be configured to receive records and/or indications of content received and/or rendered to the one or more users from a variety of sources. These sources may include third party sources that may detect content rendered and/or received by the one or more users. The records and/or indications of content rendered to the one or more users, in certain embodiments, may further be received from a provider and/or distributer of content, both in electronic form (e.g. video on demand stream) and/or physical form (e.g. a store purchase compact disk (CD)). The sources may further include the one or more users interacting with a user device to modify his/her/their content consumption history. The sources may further still include one or more providers and/or distributors (e.g. cable providers, websites, etc.) of content to the one or more users.

The third party sources, from which records and/or indications of content rendered to and/or provided to the one or more users, may include services and/or applications that may “snoop,” “watch,” and/or “hear,” content provided to the one or more users. An example of such a service or application may be one that listens to music that is rendered to the one or more users and identifies the same, such as Shazam®. Third party sources of records and/or indications of content received and/or rendered to the one or more users may further include retailers of content and/or media. For example, computers associated with a store where one buys physical media, such as a digital video disk (DVD) or compact disk (CD), may provide an indication, such as an identifier, such as an Entertainment Identifier Registry Association (EIDR) identifier, of the media content purchased by the one or more users to the content consumption history systems, in accordance with embodiments of the disclosure.

The systems and methods, as disclosed herein, further may be configured to receive content consumption and/or receipt information associated with the one or more users from a user device associated with the user. In certain embodiments, the user devices may be configured to receive and/or render content thereon. Therefore, the users may be able to access his/her content consumption history via the user device and may be able to add, modify, and or remove content, or indication thereof, bookmarks, metadata, secondary content and/or links thereto, other images, quotes, audio, haptic signals, olfactory signals, and/or video.

The user device, in certain embodiments, may further be configured to provide an indication of content received on behalf of the user and/or rendered thereon to the user. In some cases, the user device may perform instructions that enable it to determine the content received and/or rendered and then provide an indication of the same to the content consumption history systems, in accordance with embodiments of the disclosure. In some cases, the instructions may be performed by one or more processors on the user device by running an application or software that enables the user device to provide the functionality of providing an indication of content received and/or rendered on the user device.

The user device may be any variety of user devices including, but not limited to, desktop computers, laptop computers, netbook computers, personal digital assistants (PDA), tablet computing devices, smart phones, Web enabled televisions, digital video recorder (DVR) devices, game consoles, set top boxes (STB), or combinations thereof. It will be appreciated that some user devices may be unmanaged user devices, such as a laptop computer, and other user devices may be managed user devices, such as an STB. In this context, a managed user device is one that receives content from a designated content delivery infrastructure, such as a STB linked and/or associated with a particular content distributer. These managed user devices may be controlled, at least in part, by the content distributer. Signals distributed to the managed devices may include any variety of suitable signals, such as cable broadcast signals or video on demand (VOD) signals of any suitable type of modulation mechanisms, such as quadrature amplitude modulation (QAM), and any variety of transmission protocols. According to embodiments of the disclosure, user devices may receive content from a variety of sources on behalf of the one or more users and/or render content to the one or more users. The user devices may further be configured to provide an indication, such as an identifier to the systems disclosed herein for receiving, storing, providing access to, and/or modifying the content consumption history of the one or more users.

The systems and methods, as disclosed herein, may further be configured to receive content information that has been provided to and/or rendered to a user from one or more distributers and/or providers of the content. Providers and/or distributers of the content may be, for example, cable television operators, telecommunication system operators, satellite dish network operators, or the like. The content providers and/or distributer may or may not access, own, and/or operate the content delivery architecture, or portions thereof, to deliver content to one or more user devices associated with a user. Therefore, the content distributers and/or providers may be configured to provide an indication, such as an identifier, of content that has been provided to and/or consumed to the one or more users. A variety of elements within the content distribution networks, such as video back office servers, on-demand video back office servers, and/or application servers may provide the indication of content that has been provided and/or rendered to the user via a user device.

Still further, one or more websites where content may be accessed by the user may be configured to provide an indication of content provided to the user to the systems and methods disclosed herein to update the user's content consumption history. Another, yet further source of content consumption history of a use may be a website affiliated with the content. For example, a website affiliated with a particular movie may ask an individual visiting the website if he/she has viewed the movie. Based, at least in part, on the answer received, the website may provide an indication of the user's viewing history of the movie to the systems and methods as disclosed herein.

The systems and methods, as disclosed herein, may further be configured to receive information about content that has been provided to and/or rendered to a user from one or more entities that may have access to the pathways that enable network connectivity of user devices used by the user to consume content. This may be, in certain embodiments, elements of a network service provider, such as an Internet provider, to one or more devices associated with a particular user. The elements of the network service provider may be configured to “snoop” content delivered to user devices associated with the user. In certain embodiments, elements of the network service provider may be configured to perform deep packet inspection (DPI) of internet traffic, or otherwise data received by user devices associated with the user. By inspecting data and/or traffic received by user devices, the network service provider may be able to identify content that may be provided to the user via one or more user devices.

The consumption history of content by one or more users as well as additional information associated with the content consumption experience may, in certain embodiments, be stored at a remote location from the user, such as in one or more consumption history servers and associated consumption history database. The user may be able to access his/her content consumption history and/or other content experience information by accessing the consumption history servers. In one aspect, the content history may include reference to content, such as a list of consumed content. The content consumption history may be received by consumption history servers from one or more different sources, such as interaction with and/or input from the user, such as via a user device, the user device, such as via one or more applications running thereon, a content delivery/distribution architecture, and elements therein, one or more third party systems that may detect the rendering of content to the user, one or more systems associated with a physical media seller, websites that distribute content, websites affiliated with content, and/or a network service provider.

It will be appreciated that the consumption history servers may be configured to provide consumption history services and/or functionality to a plurality of users. Therefore, the consumption history servers may establish accounts associated with particular users and/or groups of users. In other words, the consumption history of one user may be segregated from the consumption history of another user by placing the consumption histories of the two users in separate accounts. In certain embodiments, user may be able to access his/her consumption history, and embellishments thereto, by accessing his/her account on the consumption history servers. In certain embodiments, establishment of a user consumption history account on the consumption history servers may involve establishing authentication credentials associated with the user. These authentication credentials and/or other user related information may be received by the consumption history servers to identify a user and his/her account with the associated user content consumption history.

The consumption history servers may further use the information received regarding content delivered and/or rendered to one or more users from a variety of sources, as described above, and update a content viewing history associated with the one or more users. A user viewing content on one or more user devices may further wish to bookmark and/or otherwise embellish portions of that content, such as locations within that he/she may want to revisit while she is watching the content or after she has watched the content by accessing the consumption history servers. The consumption history servers and associated methods, as disclosed herein, may enable the user(s) to provide these bookmarks, as well as additional information that may include favorite scenes, favorite quotes, or favorite portions of the content. The bookmarks selected by the user may be identified by the user via his/her user device and/or other entity and transmitted by the user device and/or other entity to the content consumption history servers for storage along with the content viewing history associated with the user in the user's content information account. In a non-limiting example, a user may post a bookmark, or indication thereof, on a social media site, such as on a Facebook® wall or as a Tweet®, and one or more social media servers may direct the bookmark or other metadata to the consumption history servers. Therefore, the systems, as disclosed herein, may be configured to receive an indication and/or identity of media rendered and/or received by the one or more users from a variety of sources, including, but not limited to, the user via his/her user device, one or more servers associated with a seller of physical media, third party services that may detect content consumed by the user, distributers of content, websites from which content may be accessed, websites affiliated with the content, network service providers associated with the user, one or more applications on the user device associated with the user,

Further embodiments may enable a user to store secondary content, such as images or audio clips, indications thereof, or links thereto, associated with the content that may be rendered to the user, such as, in some cases, on his/her user device. For example, a user may want to save a movie poster, or reference thereto, associated with a particular movie that he/she may be viewing or has viewed. In this case, the user may Locate the movie poster on the Internet and provide the movie poster, and/or a link or address thereto, to the content consumption servers. In this case, secondary content that is not generated by the user, or a link thereto, may be provided to the content history servers.

User generated elements may also be provided to the consumption history servers for storage along with the content consumption history. As a non-limiting example, the user may want to record an audio file to be stored along with the indication of viewing a movie. The user may, in this case, record the audio file on his/her user device or other suitable device. The audio file may subsequently be transmitted by his/her user device, by executing software and/or instructions associated with generating and managing a user content history, to the content consumption servers for storage in that user's content information account.

The consumption history server may generate a content information account associated with a user or a group of users and this account may provide the user's complete content consumption history. For example, this account may include information associated with movies or television shows viewed by the user, as well as music that the user may have listened. The user or group of users may also have stored in this content information account, dates on which particular content had been rendered to that user. Further still, the user may store bookmarks or other metadata associated with particular content indicating scenes or points within music that may be of particular interest to the user. In further cases, the user may store secondary content, such as images, video clips, text files, or audio clips associated with content that the user may have consumed. This consumption history may be accessed by the user in the future so that he/she may know his/her content consumption history, as well as any metadata, bookmarks, text, audio, images, links, or other elements that the user may have indicated on the consumption record of the content consumption history associated with the user.

It will be appreciated that in example embodiments of the disclosure, the content consumption history, rendering history tracking, tracking manipulation, secondary content linking, bookmarking, metadata linking, and/or content history retrieval functionality may be implemented as a cloud-based application that may provide these services across any variety of different user devices. In other words, the service, as described herein, are not limited to any particular user device. Indeed, the services, as described herein, may, in example embodiments, be accessed by a user by accessing a corresponding user account at a cloud-based service via any variety of user devices. In further example embodiments, the portability across user device types of the services, as described herein, may be may be enabled by the application environment being configured to determine the appropriate rendering technology to select for a variety of services, such as management of playback. For example, the application environment, may determine the playback environment (e.g., Apple HLS or 4kTV), based at least in part on any variety of factors, including, for example, on the consuming environment and/or user device type.

Example embodiments of the disclosure will now be described with reference to the accompanying figures.

Referring now to FIG. 1, an example content consumption architecture 100 where content may be received and/or rendered to a user 110, in accordance with embodiments of the disclosure. The content consumption architecture 100 may include one or more user devices 120(1)-(N), collectively or individually referred to hereinafter as user device 120, associated with the user 110. The user devices 120 may be communicatively coupled to one or more other entities of the content consumption architecture 100 via one or more networks 130. The other entities of the content consumption architecture 100 may include content provider systems 140 and elements/servers associated therewith, web servers 150 that may be configured to provide one or more websites and/or content via the networks 130, and a physical media store 160 and associated one or more servers 162. Furthermore, the content consumption architecture 100 may include one or more consumption history servers 170 and associated content history database 180. It should be noted that some of the user devices 120 may be managed devices, such as cable set top boxes (STB), televisions with integrated STBs, or satellite signal receiver. Managed devices may have one or more functionality that may be controlled by the content provider systems 140, such as a cable service provider. A managed device may be communicatively coupled directly to the content provider system 140, and elements associated therewith. Content may be provided to the managed devices via a variety of formats and/or channels, such as quadrature amplitude modulated (QAM) signals carried over any variety of communicative link, such as coaxial cables, fiber optic cables, and/or hybrid fiber and coaxial (HFC) cables. The managed user devices may be configured to receive television signals (digital or analog) through a home gateway or directly from the content providers 140. Others of the user devices 120 may be unmanaged user devices. These unmanaged user devices may be communicatively linked to the one or more networks 130 and may not be controlled by any particular provider of content. For example, the unmanaged user devices 120 may have little or no functionality that may be controlled by the content provider system 140, such as a cable service provider. The unmanaged user device 120 may include, but is not limited to, desktop computers, laptop computers, netbook computers, personal digital assistants (PDA), tablet computing devices, smart phones, Web enabled televisions, digital video recorder (DVR) device, or combinations thereof. The unmanaged devices 120 may receive content in a variety of mechanisms including, for example, streaming media over the Internet, such as from web servers 150. In some cases, the content provider system 140 may provide access to the Internet to the unmanaged user devices 120 via a variety of suitable mechanisms, such as data over cable service interface specification (DOCSIS). The transmission of content to unmanaged user devices 120 may, in certain cases, be protocol based communications, such as transmission control protocol (TCP), internet protocol (IP), hypertext transmission protocol (HTTP), or the like. In one aspect, the content may be streamed to the user device 120. In another aspect, the content may be provided to the user device 120 in a series of content segments. Therefore, the user device 120 may provide the media content that is desired by the user 110 of the user device 120 by sequentially rendering the segments of the content on an audio/visual output interface of the user device 120. The user device 120 may request a manifest file from the content provider system 140, such as an application server 146, a video back office server 142, and/or a video on demand video back office server 144. The manifest file request may include the user device 120 information, user 110 specific information, and/or content identification information.

The user devices 120 may be configured to execute one or more applications that enable the user device 120 to provide an indication of content that may be rendered on the user device 120. The user device 120 may further be configured to provide an identity of one or more users 110 associated with the user device 120. The user device 120 may be configured to provide this information to the consumption history servers 170 to update the consumption history of a user 110, such as within a content information account associated with the user 110.

The user devices 120 may further be configured to interact with the user 110 to access a content information account associated with the user 110 on the consumption history servers 170. In other words, the user 110 may be able to use his/her user device to access his/her consumption history on the consumption history servers 170 to view, modify, add to, subtract from, and/or otherwise embellish his/her consumption history. Indeed, the user may use any number of user devices and user devices at any location to remotely access his/her consumption history on the consumption history servers 170 and associated consumption history database 180.

The content provider systems 140, and its constituent elements, such as an application server 146, a video back office server 142, and/or a video on demand video back office server 144 may be configured to provide information about a user 110 content consumption history to the consumption history servers 170. The content provider systems 140 may have access to content consumption by the user 120 via his/her managed user device 120 when the content is provided by the content provider systems 140. In some cases, the content provider system 140 and associated infrastructure may be used to provide network service capability to the user device 120, such as in the case of a cable internet service offering. In this case, the content provider systems 140 may be configured to perform DPI or other “snooping” of content information provided to the user device 120 from sources other than the content provider systems 140. The information associated with content received by the user device 120 by DPI or other techniques, may be provided to the consumption history servers 170 to update the user's consumption history.

The web servers 150 may be configured to provide information and/or identifiers associated with content provided by it to the user via his/her user device and/or in physical media form. Therefore, the web servers 150 may, in certain embodiments, be configured to provide both an identity of a user 110 and content consumed by the user to update the user's consumption history. In other elements, the user 110 may access one or more web servers 150 and interact with websites and/or services provided by the web servers 150 to provide information to the web servers 150 about content that the user 110 may have consumed. The web server 150 may, based at least in part on this user interaction 110, be configured to provide an indication of one or more content consumed by the user 110, in some cases independent of the web server 150. For example, a user may provide an indication that he/she has heard a particular song from an album that may be promoted by a particular web page hosted by the web server 150. In this case, the web server 150 may provide an indication that the user 110 has heard the song to the consumption history servers 170.

The physical media store 160 may sell media, such as CDs, DVDs, books, magazines, tapes, software, games, video games, vinyl records, or the like to the user 110. The physical media store 160 may be any suitable store that may sell physical media, including, for example, a brick-and-mortar store, an online store, a warehouse club, or the like. The physical media store 160 may have one or more store servers 162 associated therewith. The store servers 162 may be configured to record and/or receive an indication of purchase of a physical media by a user 110 and provide an indication of the same to the consumption history servers 170.

The consumption history servers 170 may be configured to receive information associated with a user's viewing history. As discussed above, the consumption history servers 170 may be configured to receive this information from a variety of sources, such as those depicted in the content consumption architecture 100, including the store servers 162, web servers 150, content provider system 140, third party services, or the like. In some cases, as content is rendered or after content is rendered to a particular user via one or more user devices 120, the consumption history servers 170 may be configured to receive information such as an identification of the content that is rendered to the user 110. In some other cases, the consumption history servers 170 may be configured to receive information associated with the content that is being or has been rendered to the user 110 based upon user 110 input on a user device 120. This received user based update may be to update consumed content in the form of electronically delivered content, physical media, or shared content. An example of the shared content may be if the user 110 hears a particular song while eating at a restaurant. In still other cases, the consumption history servers 170 may be configured to receive an indication of physical media purchased from either the user 110 via his/her user device or from the store servers 162. Further still, the consumption history servers 170 may be configured to receive an indication of consumed content form the content provider system 140, web servers 150, such as those that may host content delivery services, advertising, sales, or social media services.

Upon receiving an indication of content consumption by a particular user 110, the consumption history servers 170 may further be configured to store and/or save the user's 110 or a group of users' 110 content viewing history, such as on the consumption history database 180. This content viewing history may be saved for different users 110 or groups of users 110 in separate content information accounts. Therefore, the consumption history servers 170 may be configured to create, modify, and/or delete content information accounts associated with user(s) 110.

User 110 may wish to further designate certain portion(s) of the content with a bookmark and/or metadata. The indication of this bookmark may additionally be transmitted to the consumption history servers 170, which may be configured to store the bookmark, or an indication thereof, associated with content consumed by the user 110, such as, in some cases, on his/her user device 120. The consumption history servers 170 may further be configured to receive one or more secondary content such as images, text, video clips, and/or audio clips, or links thereto, associated with the content that is part of the user's consumption history on the consumption history servers 170. The consumption history servers 170 may store any secondary content associated with a particular content in a particular user's content information account. Alternatively, the consumption history servers 170 may store an address or other metadata associated with secondary content that may be of interest to the user 110 associated with the currently rendered content via his/her user device 120. The consumption history servers 170 may be configured to receive the bookmarks, metadata, embellishments, secondary content, links, text, audio, video, or the like, associated with one or more content of the consumption history of a particular user 110 at any time (i.e. while the content is rendered or afterwards) and from any number of user device 120.

Referring now to FIG. 2 with continuing reference to FIG. 1, a user device 120 of the content distribution architecture 100 in accordance with embodiments of the disclosure is discussed. The user device 120 may include one or more user interfaces and/or input/output (I/O) devices, such as speaker(s), microphone(s), and/or display(s) 210. The user device 120 may include one or more processors 212, one or more I/O device interfaces 214, one or more network interface(s) 216, one or more storage interface(s) 218, and/or one or more memories 220. In some examples, the processors 212 of the user device 120 may be implemented as appropriate in hardware, software, firmware, or combinations thereof. Software or firmware implementations of the processors 212 may include computer-executable or machine-executable instructions written in any suitable programming language to perform the various functions described. Hardware implementations of the processors 212 may be configured to execute computer-executable or machine-executable instructions to perform the various functions described. The one or more processors 212 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 120 may also include a chipset (not shown) for controlling communications between the one or more processors 212 and one or more of the other components of the user device 120. The one or more processors 212 may also include one or more application specific integrated circuits (ASICs) or application specific standard products (ASSPs) for handling specific data processing functions or tasks.

The input/output (I/O) device(s) or user interface(s), such as the display screen 210, may be controlled via the one or more I/O device interfaces 214. The network interfaces(s) 216 may allow the user device 120 to communicate with the consumption history servers 170 and/or other elements of architecture 100, directly and/or via other elements. For example, the user device 120 may be configured to communicate with other computing devices or servers, user terminals, the content provider systems 140, the store servers 162, and/or web servers 150. The storage interface(s) 216 may enable the user device 120 to receive and transmit content or other data to one or more external storage devices.

The memory 220 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The memory 220 may store program instructions that are loadable and executable on the processor(s) 212, as well as data generated or received during the execution of these programs. Turning to the contents of the memory 220 in more detail, the memory 220 may include one or more operating systems (O/S) 222, an applications module 224, a content rendering module 226, content bookmarking module 228, a content identification module 230, and a content markup module 232. Each of the modules and/or software may provide functionality for the user device 120, when executed by the processors 212. The modules and/or the software may or may not correspond to physical locations and/or addresses in memory 220. In other words, the contents of each of the modules 222, 224, 226, 228, 230, 232 may not be segregated from each other and may, in fact be stored in at least partially interleaved positions on the memory 220.

The operating system module 222 may have one or more operating systems stored thereon. The processors 212 may be configured to access and execute one or more operating systems stored in the operating system module 222 to operate the system functions of the electronic device. System functions, as managed by the operating system may include memory management, processor resource management, driver management, application software management, system configuration, and the like. The operating system may be any variety of suitable operating systems including, but not limited to, Google® Android®, Microsoft® Windows®, Microsoft® Windows® Server®, Linux, Apple® OS-X®, or the like. The application module 224 may contain instructions and/or applications thereon that may be executed by the processors 212 to provide one or more services to the user. These instructions and/or applications may, in certain aspects, interact with the operating system module 222 and/or other modules of the user device 120.

The content rendering module 222 may have stored thereon instructions and/or programs that when executed by the processors 212, may enable the user device 120 to perform a variety of functions associated with rendering content on the user device 120. In one aspect, the processors 212 may be configured to display video on the screen 210 based at least in part on a received content. In another aspect, the processors 212 may be configured to provide sound from one or more speakers associated with the user device 120 based at least in part on the received content. The content, such as media files, may be of any suitable form, including data files, image files, video files, audio files, or combinations thereof.

In one aspect, the processors 212 may be configured to receive the content from any suitable location, such as from a variety of elements of the content provider system 140 or web servers 150. For example, is the user device 120 is a managed device, such as a STB, the content may be received directly from the content provider system 140. The content may be in a legacy format and may be either a broadcast and/or multicast transmission or a media on demand (MOD) transmission. In the latter case, the user 110 may select the MOD content and it may be provided to the user device 120 in an asynchronous manner relative to other consumers of the same content.

If the user device 120 is an unmanaged device or a managed user device, the content may be received by the user device in the form of streaming content. In this case, the user device 120 and the processors 212 thereon may receive a playlist or manifest file that indicates segments of content, and addresses thereof, that comprise the content to be rendered. The user device 120 and the processors 212 thereon may utilize the manifest file to receive and/or retrieve the appropriate segments of content from the CDN 140 and/or the origin server 164. The format of the streaming content may include any suitable format, including, but not limited to, Apple® hypertext transmission protocol (HTTP) Live Streaming (HLS)®, Microsoft® Silverlight Smooth Streaming (SS)®, Adobe® HTTP Adaptive Streaming (HDS)®, Moving Picture Expert's Group (MPEG)® Dynamic Adaptive Streaming with HTTP (DASH)®, or combinations thereof.

The processors 212 may, by executing instructions stored in the content rendering module 226, further provide session related functionality, such as ability to pause, play, stop, fast forward, or reverse the content. This functionality may further be provided when a user 110 wants to memorialize and/or update a content history from the current user device 120 on a remote entity, such as the consumption history servers 170.

The content bookmarking module 228 may have store thereon instructions and/or programs that when executed by the processors 212 may enable the user device 120 to perform a variety of functions associated with receiving and directing a bookmark associated with content that may be rendered on the user device 120 to a user 110. The processors 212 may be configured to receive input from a user 110 using the user device 120 indicating a particular bookmark that he/she would like to set. Indeed, a user 110 may pause the currently rendered content on user device 120 to indicate a bookmark. In some cases, the user 110 may rewind or jog in a reverse or forward direction to identify the particular point that he/she would like to bookmark in the content. The instructions stored in the content bookmarking module 228, therefore, may enable the processor 212 to receive the indication of the bookmark and transmit that indication to the consumption history servers 170 for incorporation in a content information account associated with the user 110. The transmission may be via the networks 130 or other suitable communicative links between the user device 120 and the consumption history servers 170. In certain embodiments, the content bookmarking module 228 may have instructions stored thereon that when executed by processors 212 may enable the user device 120 to provide bookmarks and/or other metadata to embellish a consumption history after the content has already been rendered to the user 110, rather than during the rendering.

The content identification module 230 may have store thereon instructions and/or programs that when executed by the processors 212 may enable the user device 120 to identify content that is rendered on the user device 120 and transmit an indication of that identification to the consumption history servers 170 and/or other entities. In certain aspects, the processors 212 may be configured to identify an identification associated with content that is rendered on the user device 120 such as a universal unique identifier, such as the entertainment identifier registry identifier (EIDR) associated with content. This identifier may be transmitted by the processors 212 from the user device 120 to one or more entities of the content consumption architecture 100 such as the consumption history servers 170 via the networks 130 or other suitable communicative links. In some cases, especially when the user device 120 is an unmanaged device, the identification of the currently rendered content may involve multiple processes. These processes may involve analyzing one or more data packets associated with content that is received and/or rendered on the user device 120. For example, DPI may be used to determine what content is rendered on the user device. In this case, the processors 212 or other entities in cooperation with processors 212 may be configured to analyze the one or more data packets associated with content that is rendered on the user device 120.

The content mark-up module 232 may have stored thereon instruction and/or programs that when executed by the processors 212 may enable the user device 120 to perform a variety of content mark-up, metadata, secondary, and/or associated content functions. In one aspect, the processors 212 may be configured to capture portions of the content such as images, such as an image frame, or video clips from a video. In other aspects, the processors 212 may be configured to identify and/or receive secondary content, such as images and/or audio, associated with the content. For example, the processors 212 may be configured to identify a movie poster associated with a particular content in the form of a movie and access the Internet to retrieve the movie poster associated with the movie. In yet other cases, the processors 212 may be configured to receive input from the user 110 on the user device 120 associated with the content rendered on the user device 120. For example, a user 120 may choose to speak his/her favorite quote from the movie in his/her own voice and save that content to that user's content information account. Therefore, once the processors 212 and the user device 120 executing instructions stored in the content mark-up module 232 receive one or more second content and/or metadata, such as text, associated with the currently rendered content, the one or more secondary content and/or metadata may be transmitted. The one or more secondary content or metadata, or indications thereof, may be transmitted by the user device 120 to the consumption history servers 170 or other entities associated with the content consumption architecture 100.

It will be appreciated that there may be overlap in the functionality of the instructions stored in the applications module 224, content rendering module 226, content bookmarking module 228, content identification module 230, and the content markup module 232. In fact, the functions of the aforementioned modules 226, 228, 230, 232 may interact and cooperate seamlessly under the framework of the user device 120. Indeed, each of the functions described for any of the modules 226, 228, 230, 232 may be stored in any module 226, 228, 230, 232 in accordance with certain embodiments of the disclosure. Further, in certain embodiments, there may be one single module that includes the instructions, programs, and/or applications described within the applications module 224, content rendering module 226, content bookmarking module 228, content identification module 230, and the content markup module 232.

Referring now to FIG. 3 with continued reference to FIG. 1, the consumption history servers 170 of the content consumption architecture 100, in accordance with embodiments of the disclosure, is discussed. Similar to the user device 120 as described in reference to FIG. 2, the consumption history servers 170 may include one or more processors 312, one or more I/O device interfaces 314, one or more network interface(s) 316, one or more storage interface(s) 318, and/or one or more memories 320. The one or more processors 312, one or more I/O device interfaces 314, one or more network interface(s) 316, one or more storage interface(s) 318, and one or more memories 320 of the consumption history servers 170 may be similar to the corresponding components 212, 214, 216, 218, respectively, of the user device 120, and in the interest of brevity, the descriptions of these elements 312, 314, 316, and 318 will not be repeated here.

Turning to the contents of the memory 320 in more detail, the memory 320 may include one or more operating systems (O/S) 322, an applications module 324, a user management module 326, a user history module 328, a content information module 330, and a content analysis module 332. Each of the modules and/or software may provide functionality for the consumption history servers 170, when executed by the processors 312. The O/S module 322 and the applications module 324 of the consumption history servers 170 may be similar to the corresponding modules 222, 224, respectively, of the user device 120, and in the interest of brevity, the descriptions of these elements will not be repeated here.

The user management module 326 may have stored thereon instructions and/or programs that when executed by the processors 312 enable the consumption history servers 170 to manage various aspects of users 110 and accounts associated with those users 110, such as content information accounts. In some cases, the processors 312 may be configured to create new content information accounts associated with one or more users 110. The processors 312 may further be configured to modify and/or edit content information accounts associated with one or more users 110. These content information accounts may store a content viewing history of a particular user 110 or group of users 110, such as a family, including an identification of the content rendered to the one or more users 110 as well as a time and date when that content was rendered to the user. The content information account may further include bookmarks associated with content such as a particular point in the content that a user may want to mark associated with the content in the content history of the user 110. The content information account associated with the one or more users 110 may further include one or more secondary content such as images, sounds, video clips and/or text, or portions thereof, associated with content that has been rendered to the one or more users 110.

The user history module 328 may have stored thereon instructions and/or programs that when executed by the processors 312 enable the consumption history servers 170 to manage various aspects of a particular user's consumption history and content indicated therein. This may include receiving consumption information, such as from user devices 120 or other entities of the content consumption architecture 100, associated with content that is rendered to and/or received by a user 110. In addition, the processors 312 may be configured to receive secondary content, notes, and/or bookmarks associated with content has been rendered to a user 110 via his/her user device 120. The user history module 328, therefore, may have instructions stored thereon that enable the processor 312 to access, create, edit, modify, and/or delete content information accounts associated with one or more users 110.

The content information module 330 may have instructions and/or programs stored thereon that when executed by the processors 312 enable the consumption history servers 170 to perform various processes associated with identifying content information. In certain aspects, the processes enabled by the content information module 330 may cooperate with the processes enabled by the user history module 328 and/or the user management module 326 to identify content that may have been rendered to one or more users 110 via their user device(s) 120. In certain embodiments, the processors 312, in some cases in cooperation with other entities of content delivery architecture 100, may be configured to perform DPI to ascertain content that is delivered to one or more users 110 via their user device 120. Techniques that examine data packets transmitted to the user device 120 may be used, in some cases, to identify content delivered to unmanaged user devices 120 and/or by third party providers of content via the CND 140.

The content analysis module 332 may have stored thereon instructions and/or programs that when executed by the processors 312 enable the consumption history servers 170 to perform various analyses on a content history such as content histories stored in content information accounts. The processors 312 may be configured to access and analyze a single content information account to ascertain content that should be recommended to users 110 associated with the analyzed content information account. Additionally, the processors 312 may be configured to analyze a plurality of content information accounts and determine therefrom monetary values that should be associated with particular content. In other words, if a particular content is more popular than other types of content that particular popular content may be priced at a higher level than other content.

It will be appreciated that there may be overlap in the functionality of the instructions stored in the applications module 324, user management module 326, user history module 328, content information module 330, and content analysis module 332. In fact, the functions of the aforementioned modules 326, 328, 330, 332 may interact and cooperate seamlessly under the framework of the consumption history servers 170. Indeed, each of the functions described for any of the modules 326, 328, 330, 332 may be stored in any module 326, 328, 330, 332 in accordance with certain embodiments of the disclosure. Further, in certain embodiments, there may be one single module that includes the instructions, programs, and/or applications described within the applications module 324, user management module 326, user history module 328, content information module 330, and content analysis module 332.

Referring now to FIG. 4, an example method 400 for transmitting a content history, bookmark, and/or second content associated with content consumption history is depicted, in accordance with the embodiments of the disclosure. The method 400 may be performed by a user device 120 in cooperation with one or more other entities of the content consumption architecture 100, such as consumption history servers 170. At block 402, content for display based on one or more user inputs may be received. The one or more user input may be provided via a variety of user interfaces or other mechanisms for user interaction such as a remote control associated with a STB, a laptop computer, a smartphone, or other suitable electronic communications devices. Therefore, a user may select content to be displayed on his/her user device 120 and that content may be supplied to the user device 120 by the content delivery architecture 100.

At block 404, the received content may be rendered on the display 210 of the user device 120. In certain embodiments, the content may not have a video or image component and, in those cases, audio of the content may be rendered on the user device 120. At block 406, a message may be transmitted that indicates one or more users associated with the content that is displayed on the user device 120. In some cases, a particular user device 120 may always indicate the same one or more users 110. In other cases, there may be different groups of one or more users that use a particular user device 120 and, in these cases, a particular group of one or more users 110 may be indicated by the user device 120 as consuming the content.

At block 408, a message indicating the identity of the content that is currently rendered on the user device 120 may be transmitted. This message may be transmitted by the user device 120 to the consumption history servers 170 and may be indicative of content that has been rendered to the particular user(s) as indicated in block 406. In some cases, the message indicating the content rendered may be generated by an application or software operating on the user device and the processors 212 thereon, independent of software or applications used in rendering the content on the user device 120. In this case, the software and/or application that determines the content that is being rendered on the user device 120 may interact with and/or monitor the software or application that is executed to render the content on the user device 120. Therefore, upon generating and transmitting the message indicating the content rendered by the user device 120, the consumption history servers 170 may have information related to content that is rendered to a particular user 110.

At block 410, an indication of user marking of the content may be received. This marking may be text that may be generally associated with the content that a particular user 110 may indicate on content that is rendered to him/her. The user marking of the content may subsequently be transmitted by the user device to the VBO servers at block 412. At this point, the consumption history servers 170 may be configured to store the user marking of the content along with an indication of the content being rendered to the user 110.

At block 414, a bookmark and/or second content associated with the content may be received. As discussed above, the bookmark may be a point within the content that the user 110 may indicate as particularly interesting and may choose to reference at a later time. The second content associated with the content, as described earlier, may include an image, a video clip, an audio clip, or text information that may be stored along with an indication of the content being rendered to the user 110. At block 416, the received bookmark and/or second content associated with the content may be transmitted. This information may be transmitted by the user device 120 on behalf of the user 110 identified in block 406 to the consumption history servers 170. The information may be transmitted in the form of one or more data packets and may further contain routing information for the destination, such as the consumption history servers 170 and one or more transmission integrity checks, such as a parity bit or a cyclic redundancy check (CRC). At block 418, a confirmation of receipt of the bookmark and/or second content may be received. In this case, this confirmation may be transmitted by the consumption history servers 170 to the user device 120.

It will be appreciated that upon execution of method 400, the user device 120 has provided information to the consumption history servers 170 to generate and/or update a content information account of a user 110. This information may include an identification of one or more users 110 with which the content information account may be associated, as well as content that has been rendered to the one or more users 110. Additionally, user marking of the content may be provided to the consumption history servers 170. Further still, a bookmark may be provided to the consumption history servers 170 to indicate particular points along the rendered content that may be of particular interest to the user 170. Further still, a second content associated with the content may be provided to the consumption history servers 170. The second content may include a variety of images audio or video files and, in some cases, the second content may not be stored in physical form but an address associated with the second content may be stored in the user's content information account to indicate secondary content that may be of interest to the user 110.

It should be noted, that the method 400 may be modified in various ways in accordance with certain embodiments of the disclosure. For example, one or more operations of method 400 may be eliminated or executed out of order in other embodiments of the disclosure. Additionally, other operations may be added to method 400 in accordance with other embodiments of the disclosure.

Referring now to FIG. 5, an example method 500 for rendering a user's consumption history, bookmarks and/or other content is depicted, in accordance with embodiments of the disclosure. The method 500 may be performed by the user device 120 in cooperation with other entities of the content delivery architecture 100 such as the consumption history servers 170. At block 502, a content information account associated with one or more users may be accessed. This access may involve authentication of the one or more users. Authentication may involve, in certain cases, providing a log-in and password associated with the one or more users 110 by the user device 120 to the consumption history servers 170 to access the particular content information account associated with the one or more users 110. Additionally, in some cases, additional authentication information or data may be required to access the content information account associated with the one or more users 110. For example, biometric data may be used in the authentication process such as voice recognition, retinal scans, or finger prints associated with at least one of the one or more users 110.

Once the content information account has been accessed by the user device 120, the one or more user's content consumption history, including listing of content consumed, bookmarks, metadata, links to secondary content, personal content, and/or other content may be received by the user device at block 504. This information may be sent by the consumption history servers 170 to the user device 120. The user device 120 may execute applications and/or software thereon for interfacing with and receiving the consumption history form the consumption history servers 170. and providing the information to the user 110 using one or more input or output components of the user device 120.

At block 506, the user's content consumption history may be rendered on the user device 120 to the one or more users 110. It will be appreciated that by executing the processes of method 500 a user device 120 may provide a user 110 with either his/her full or partial content consumption history with listing of content consumed, bookmarks, metadata, links to secondary content, personal content, and/or other content that the user 110 may have associated with his/her consumption history. The consumption history that is viewed by the user 110 may, in some cases, be a consumption history over a relatively long stretch of time, such as years or even the user's content viewing lifetime. Furthermore, the content consumption history may, in some cases, include a wide variety of content and represent a wide variety of sources of content. In some cases, the user 110 may be presented with advertising when viewing his/her content consumption history.

It should be noted, that the method 500 may be modified in various ways in accordance with certain embodiments of the disclosure. For example, one or more operations of method 500 may be eliminated or executed out of order in other embodiments of the disclosure. Additionally, other operations may be added to method 500 in accordance with other embodiments of the disclosure.

Referring now to FIG. 6, an example method 600 for creating and/or updating a content information account is provided in accordance with embodiments of the disclosure. This method 600 may be performed by the consumption history servers 170 in cooperation with other elements of the content delivery architecture 100, such as user device 120. At block 602, one or more users may be identified and a content information account associated with the one or more users may be accessed. As described in conjunction with method 500 of FIG. 5, the access to the content information account may require authentication such as using a log-in and password.

At block 604, an indication of content associated with the one or more users may be received. The consumption history servers 170 may receive the indication of the content from the user device 120. The content associated with the one or more users 110 may be a content that is currently being rendered by the user device 120 to the one or more users 110. The indication of the content may be received in a variety of formats such as an entertainment identifier registry format (EIDR) or other unique content identifiers, such as video on demand provider identifier and provider asset identifier (PID/PAID). In some embodiments, the indication of the content associated with the one or more users 110 may be received from an entity other than the user device 120. For example, in cases where the content is rendered on an unmanaged user device 120, a DPI may be performed by one or more entities associated with the networks 130. In addition, content history associated with a user 110 may be received from a content provider system 140, web servers 150, and/or store servers 162.

At block 606, the content information account may be updated with the indication of the content rendered to and/or received by the user 110. In certain embodiments, the update may be performed at the same time that the content may be rendered to the user 110 via user device 120. The content information account may be of any suitable format including, but not limited to, a list, table, or chart indicating content that have been rendered to the user 110 via one or more user devices 120. At block 608, a bookmark associated with the content may be received. This bookmark may be received from the user device 120 based at least in part on user 110 interaction with the user device 120.

Upon receiving the bookmark associated with the content, the consumption history servers 170 may, at block 610, indicate the bookmark of the content in the consumption history of the content information account. This indication may entail listing the position or time of the content where the bookmark is desired. For example, if the content information account is a chart that indicates each of the content that have been rendered to the user 110 under the particular content that is currently rendered to the user 110, a bookmark may be listed. At block 612, a second content associated with the current content may be received. As described earlier, the second content may be any variety of text, images, video and/or audio that the user may want to link with the current and/or historic content as listed in the consumption history of the user 110. The user 110 may provide the second content on a user interface of the user device 120 and that second content may be transmitted by the user device 120 to the consumption history servers 170 for storage in the content information account associated with the user 110. In some cases, the actual second content may not be stored but, instead, an address, link, or an indication of the second content may be stored in the user's content information account.

It will be appreciated that upon execution of method 600 a particular user's content information account may be generated and/or updated based upon content that is rendered to the user 110 via his/her user device 120. This method may operate by interaction between the user's user device 120 and the consumption history servers 170 or other entities of the content delivery architecture 100.

It should be noted, that the method 600 may be modified in various ways in accordance with certain embodiments of the disclosure. For example, one or more operations of method 600 may be eliminated or executed out of order in other embodiments of the disclosure. Additionally, other operations may be added to method 600 in accordance with other embodiments of the disclosure.

Referring now to FIG. 7, a schematic diagram depicting example information 700 provided by the user device 120 to the consumption history servers 170 to create and/or update a content information account is depicted in accordance with embodiments of the disclosure. As shown, user input 710 may be provided to user device 120 rendering content 720. For example, a bookmark may be indicated by the user 110 via user input 710 on the user device 120. The user 110 may indicate a bookmark along the length of the content 720 rendered on the user device 120 and indicated by a marker 728, 730. At this point, the user device may generate information associated with the user input 710 as depicted in information elements 740. The information elements 740 may provide an indication of a favorite scene 750, a frame capture 754, and/or a scene time within the content 758 such as a bookmark. Therefore, the favorite scene 750 may be a bookmark and the time 758 associated with that bookmark may be provided by the user device 120 to the consumption history servers 170. Additionally, the user 110 may choose to capture that scene associated with the bookmark and provide that frame capture 754 from the user device 120 to the consumption history servers 170 for storage with his/her content information account.

Referring now to FIG. 8, an example content information account 800 is depicted on a user interface 210 of a user device 120. The content information account may be depicted with a title 804 followed by listing of content that the associated user 110 has viewed. Each of these content may further include bookmarks and/or second content associated therewith that may have been designated by the user 110. As shown, TV show A, episode 3, season 2 810 is shown in the viewing history. In addition, a favorite scene at scene/time marker 4:32 812 is depicted. A screen shot at 12:21 814 may be associated with the viewing history and designated by the user 110. The viewing history may also include movie B 820. In this entry a favorite quote 822 may be associated with movie B 820. Additionally, a favorite clip from time 4:12 to time 5:07 for a total of 55 seconds 824 may be depicted with movie B 820. The viewing history may further include song C 830 and album art 836 may be associated with song C 830. The viewing history 800 may further include song D 840 and an indication of posting this song to social media wall may be indicated 842.

It will be appreciated that while a particular format for rendering the viewing history 800 of a particular user 110 is depicted, the viewing history may be rendered to the user 110 in a variety of formats and may include a variety of information and/or links such as hyperlinks to primary or secondary content. It will further be appreciated that the content consumption history may be accessed from anywhere and at any time by the user 110. In addition, in some cases, suggested content may be provided to the user 110 based upon the viewing history 800 as depicted. For example, additional suggestion of content may be provided on the viewing history to content that may be similar to content that has been viewed by the user 110. In certain embodiments, advertising may be displayed along with the viewing history 800.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method, comprising:
identifying, by a user device comprising one or more processors, one or more users associated with a received content;
transmitting, by the user device, an indication of the one or more users associated with the content received by the user device based at least in part on the identifying the one or more users; and
transmitting, by the user device, an indication of an identification of the received content.

2. The method of claim 1, further comprising:
receiving, by the user device, a bookmark associated with the content; and
transmitting, by the user device, the bookmark associated with the content.

3. The method of claim 1, further comprising:
receiving, by the user device, a second content associated with the content; and
transmitting, by the user device, the second content associated with the content.

4. The method of claim 3, wherein the second content is at least one of: (i) one or more images; (ii) one or more video clips; (iii) one or more audio clips; or (iv) text; (v) meta-content; (vi) link to content; (vii) gaming content; (viii) haptic content; or (ix) time stamp.

5. The method of claim 1, wherein the user device is at least one of: (i) a managed user device; or (ii) an unmanaged user device.

6. The method of claim 1, further comprising receiving, by the user device, a message indicating a receipt of the identification of the content rendered on the user device.

7. At least one computer-readable medium comprising computer-executable instructions that, when executed by one or more processors, executes a method comprising: displaying a content on the display screen;
identifying one or more users associated with the content; and
transmitting an identifier of the one or more users and an identifier of the content.

8. The at least one computer-readable medium of claim 16, wherein the method further comprises:
receiving a bookmark associated with the content; and
transmitting the bookmark associated with the content.

9. The at least one computer-readable medium of claim 16, wherein the method further comprises:
receiving a second content associated with the content; and
transmitting the second content associated with the content.

10. The at least one computer-readable medium of claim 16, wherein the method further comprises:
receiving authentication credentials associated with the one or more users;
transmitting the authentication credentials associated with the one or more users, wherein the authentication credential provide access to a content information account of the one or more users on a consumption history server.

11. A method, comprising:
receiving, by a consumption history server comprising one or more processors, an indication of one or more users;
identifying, by the consumption history server, a content information account associated with the one or more users;
receiving, by the consumption history server, an identification of a content rendered to the one or more users; and
recording, by the consumption history server, the identification of the content in the content information account.

12. The method of claim 11, wherein receiving an indication of the one or more users comprises identifying, by the consumption history server, a user device associated with the one or more users.

13. The method of claim 11, further comprising:
receiving, by the consumption history server, a bookmark associated with the content; and
storing, by the consumption history server, the bookmark associated with the content in the content information account.

14. The method of claim 11, further comprising:
receiving, by the consumption history server, a second content associated with the content; and
storing, by the consumption history server, the second content associated with the content in the content information account.

15. The method of claim 14, wherein the second content is at least one of: (i) one or more images; (ii) one or more video clips; (iii) one or more audio clips; or (iv) text.

16. The method of claim 11, wherein identifying the content information account comprises receiving, by the consumption history servers, authentication information associated with the content information account.

17. The method of claim 11, wherein receiving the identification of the content rendered to the one or more users comprises analyzing one or more data packets associated with the content.

18. The method of claim 11, further comprising transmitting, by the video back office server, a message indicating a receipt of the identification of the content rendered on the user device.

19. A system, comprising:
at least one memory that stores computer-executable instructions;
at least one processor configured to access the at least one memory, wherein the at least one processor is configured to execute the computer-executable instructions to:
receive an indication of one or more users;
identify a content information account associated with the one or more users;
receive an identification of a content rendered to the one or more users; and
record the identification of the content in the content information account.

20. The system of claim 19, wherein the at least one processor is configured to execute the computer-executable instructions to further:
receive a bookmark associated with the content; and
store the bookmark associated with the content in the content information account.

21. The system of claim 19, wherein the at least one processor is configured to execute the computer-executable instructions to further:
receive a second content associated with the content; and
store the second content associated with the content in the content information account.

22. The system of claim 20, wherein the second content is at least one of: (i) one or more images; (ii) one or more video clips; (iii) one or more audio clips; or (iv) text.

23. The system of claim 19, wherein to receive the identification of the content rendered to the one or more users comprises analyzing one or more data packets associated with the content.
